(19) United States
(12) Patent Application Publication
(10) Pub. No.: US 2012/0162588 A1
(43) Pub. Date: Jun. 28, 2012

(54) LIQUID CRYSTAL ALIGNMENT AGENT, AND LIQUID CRYSTAL ALIGNMENT FILM AND LIQUID CRYSTAL DISPLAY ELEMENT FORMED FROM THE LIQUID CRYSTAL ALIGNMENT AGENT

(75) Inventor: Tsung-Pei TSAI, Tainan City (TW)

(73) Assignee: Chi Mei Corporation, Tainan City (TW)

(21) Appl. No.: 13/243,633

(22) Filed: Sep. 23, 2011

(30) Foreign Application Priority Data
Dec. 28, 2010 (TW) 099146301

(51) Int. Cl. G02F 1/1337

(52) U.S. Cl. 349/123; 349/191

(57) ABSTRACT

Disclosed is a liquid crystal alignment agent which includes: a polymer obtained by subjecting a diamine compound and a tetracarboxylic dianhydride compound to a polymerization reaction; an epoxy group containing compound; and a curing promoter. The curing promoter is at least one compound selected from secondary amines, tertiary amines, quaternary ammonium compounds, organic phosphines, imidazoles, and tetraphenyl borates, and is in an amount ranging from 0.5 to 10 parts by weight based on 100 parts by weight of the polymer. A liquid crystal alignment film formed from the liquid crystal alignment agent and a liquid crystal display element including the liquid crystal alignment film are also disclosed.

### CROSS-REFERENCE TO RELATED APPLICATION

This application claims priority of Taiwanese Application No. 099146301, filed on Dec. 28, 2010.

### BACKGROUND OF THE INVENTION

1. Field of the Invention

This invention relates to a liquid crystal alignment agent, more particularly to a liquid crystal alignment agent having improved alignment properties. The invention also relates to a liquid crystal alignment film formed from the liquid crystal alignment agent, and a liquid crystal display element including the liquid crystal alignment film. The liquid crystal display element produced from the liquid crystal alignment agent of this invention has improved voltage holding ratio and reliability.

2. Description of the Related Art

Nematic liquid crystal display elements are predominantly used in general liquid crystal display elements, and concrete examples of the nematic liquid crystal display elements actually used include: (1) a TN (Twisted Nematic) liquid crystal display element, in which a liquid crystal alignment direction of one side substrate is twisted at a 90 degree angle relative to a liquid crystal alignment direction of the other side substrate; (2) a STN (Super Twisted Nematic) liquid crystal display element, in which a liquid crystal alignment direction of one side substrate is twisted at an angle greater than 180 degrees relative to a liquid crystal alignment direction of the other side substrate; and (3) a TFT (Thin Film Transistor) liquid crystal display element which uses a thin film transistor.

Recently, to address the problem of the viewing angle of the display panel, the following solutions are provided: (1) a TN liquid crystal display element with an optical compensation film; (2) a VA (Vertical Alignment) liquid crystal di splay element with an optical compensation film; (3) a MVA (Multi-domain Vertical Alignment) liquid crystal display element which utilizes both a vertical alignment technique and a protrusion technique; (4) an IPS (In-Plane Switching) liquid crystal display element which utilizes a transverse electrical field effect technique; (5) an ECB (Electrically Controlled Birefringence) liquid crystal display element; and (6) an OCB (Optically self-Compensated Birefringence) liquid crystal display element.

In the above mentioned liquid crystal display elements, the main material for controlling the liquid crystal alignment is the liquid crystal alignment film, and a pretilt angle is formed by the liquid crystal alignment film. Conventionally, the liquid crystal alignment agent is formulated by dissolving polyamic acid or polyimide in an organic solvent, and is then applied and cured on a substrate to form the liquid crystal alignment film. Two substrates each having the liquid crystal alignment film formed thereon are prepared and arranged to oppose each other with a space (cell gap). The peripheral portions of the two substrates are joined together with a sealing agent, liquid crystals are filled into the cell gap defined by the surfaces of the substrates and the sealing agent, and an injection hole is sealed up to form a liquid crystal cell.

However, in the conventional process of an alignment treatment of the liquid crystal alignment film, a crack is liable to form in the surface. Moreover, the alignment performance may be reduced in the water washing process after the alignment treatment is completed, thereby degrading the alignment property.

Therefore, to further improve the alignment characteristics of the liquid crystal alignment film, various alignment agents with different chemical structures have been proposed in the art. For example, JP 7234410 (A) and JP 2006-023344 disclose an alignment agent which includes a compound containing one or at least two epoxy groups in one molecule. JP 10-333153 discloses an alignment agent which includes polyamic acid, polyimide, and an epoxy group containing compound having nitrogen atoms in the molecule thereof. By means of a cross linking reaction generated after the epoxy group containing compound is reacted at an elevated temperature, the disadvantage of easy formation of a crack in the conventional alignment film during the alignment process or the degraded alignment property after the water washing can be overcome.

However, the alignment film produced by heating the aforementioned alignment agent including an epoxy group containing compound can result in reduced voltage holding ratio and poor reliability of the produced liquid crystal display element due to the incomplete reaction residue of the epoxy group.

It is required in the art to provide a liquid crystal alignment agent which has a good alignment performance so that the produced liquid crystal display element can have good reliability and high voltage holding ratio.

### SUMMARY OF THE INVENTION

Therefore, an object of the present invention is to provide a liquid crystal alignment agent.

Another object of the present invention is to provide an alignment film formed from the liquid crystal alignment agent.

A further object of the present invention is to provide a liquid crystal display element including the liquid crystal alignment film.

According to a first aspect of this invention, there is provided a liquid crystal alignment agent, which includes: a polymer obtained by subjecting a diamine compound and a tetracarboxylic dianhydride compound to a polymerization reaction; an epoxy group containing compound; and a curing promoter. The curing promoter is at least one compound selected from the group consisting of secondary amines, tertiary amines, quaternary ammonium compounds, organic phosphines, imidazoles, and tetraphenyl borates, and is in an amount ranging from 0.5 to 10 parts by weight based on 100 parts by weight of the polymer.

According to a second aspect of this invention, there is provided a liquid crystal alignment film formed from the liquid crystal alignment agent of this invention.

According to a third aspect of this invention, there is provided a liquid crystal display element including the liquid crystal alignment film of this invention.

In accordance with the present invention, the voltage holding ratio and the reliability of the liquid crystal display element can be enhanced by using the liquid crystal alignment agent of the present invention.

### BRIEF DESCRIPTION OF THE DRAWING

Other features and advantages of the present invention will become apparent in the following detailed description of the preferred embodiments with reference to the accompanying drawing, of which:

FIG. 1 is a fragmentary schematic view of a preferred embodiment of a liquid crystal display element according to this invention.

### DETAILED DESCRIPTION OF THE PREFERRED EMBODIMENTS

The liquid crystal alignment film of the present invention is obtained by applying a liquid crystal alignment agent on a transparent substrate, which will be described in detail hereinafter.

The liquid crystal alignment agent includes: a polymer obtained by subjecting a diamine compound and a tetracarboxylic dianhydride compound to a polymerization reaction; an epoxy group containing compound; and a curing promoter. The curing promoter is at least one compound selected from the group consisting of secondary amines, tertiary amines, quaternary ammonium compounds, organic phosphines, imidazoles, and tetraphenyl borates, and is in an amount ranging from 0.5 to 10 parts by weight based on 100 parts by weight of the polymer.

The diamine compounds used in the present invention include aliphatic or alicyclic diamine compounds, aromatic diamine compounds, or other diamine compounds.

Examples of aliphatic or alicyclic diamine compounds include, but are not limited to, 1,3-diaminopropane, 1,4-diaminobutane, 1,5-diaminopentane, 1,6-diaminohexane, 1,7-diaminoheptane, 1,8-diaminooctane, 1,9-diaminononane, 4,4-diaminoheptamethylenediamine, 1,4-diaminocyclohexane, isophoronediamine, tetrahydrobicyclopentadienylenediamine, hexahydro-4,7-methanoindanylenedimethylenediamine, tricyclic[6.2.1.0^{2,7}]-undecylenedimethyldiamine, and 4,4′-methylenebis(cyclohexylamine).

Examples of aromatic diamine compounds include, but are not limited to, p-phenylenediamine, m-phenylenediamine, o-phenylenediamine, 4,4′-diaminodiphenylmethane, 4,4′-diaminodiphenylethane, 4,4′-diaminodiphenylsulfide, 4,4′-diaminodiphenylsulfone, 3,3′-dimethyl-4,4′-diaminobiphenyl, 4,4′-diaminobenzanilide, 4,4′-diaminodiphenyl ether, 1,5-diaminonaphthalene, 2,2′-dimethyl-4,4′-diaminobiphenyl, 5-amino-1-(4′-aminophenyl)-1,3,3-trimethylindane, 6-amino-1-(4′-aminophenyl)-1,3,3-trimethylindane, 3,4′-diaminodiphenyl ether, 3,3′-diaminobenzophenone, 3,4′-diaminobenzophenone, 4,4′-diaminobenzophenone, 2,2-bis[4-(4-aminophenoxy)phenyl]propane, 2,2-bis[4-(4-aminophenoxy)phenyl]hexafluoropropane, 2,2-bis(4-aminophenyl)hexafluoropropane, 2,2-bis[4-(4-aminophenoxy)phenyl]sulfone, 1,4-bis(4-aminophenoxy)benzene, 1,3-bis(4-aminophenoxy)benzene, 1,3-bis(3-aminophenoxy)benzene, 9,9-bis(4-aminophenyl)-10-hydroanthracene, 2,7-diaminofluorene, 9,9-bis(4-aminophenyl)fluorene, 4,4′-methylene-bis(2-chloroaniline), 2,2′,5,5′-tetrachloro-4,4′-diaminobiphenyl, 2,2′-dichloro-4,4′-diamino-5,5′-dimethoxybiphenyl, 3,3′-dimethoxy-4,4′-diaminobiphenyl, 4,4′-(p-phenyleneisopropylidene)bisaniline, 4,4′-(m-phenyleneisopropylidene)bisaniline, 2,2′-bis[4-(4-amino-2-trifluoromethylphenoxy)phenyl]hexafluoropropane, 4,4′-diamino-2,2′-bis(trifluoromethyl)biphenyl, and 4,4′-bis[(4-amino-2-trifluoromethyl)phenoxy]octafluorobiphenyl.

Examples of other diamine compounds include, but are not limited to, 2,3-diaminopyridine, 2,6-diaminopyridine, 3,4-diaminopyridine, 2,4-diaminopyrimidine, 5,6-diamino-2,3-dicyanopyrazine, 5,6-diamino-2,4-dihydroxypyrimidine, 2,4-diamino-6-dimethylamino-1,3,5-triazine, 1,4-bis(3-aminopropyl)piperazine, 2,4-diamino-6-isopropoxy-1,3,5-triazine, 2,4-diamino-6-methoxy-1,3,5-triazine, 2,4-diamino-6-phenyl-1,3,5-triazine, 2,4-diamino-6-methyl-s-triazine, 2,4-diamino-1,3,5-triazine, 4,6-diamino-2-vinyl-s-triazine, 2,4-diamino-5-phenylthiazole, 2,6-diaminopurine, 5,6-diamino-1,3-dimethyluracil, 3,5-diamino-1,2,4-triazole, 6,9-diamino-2-ethoxyacridine lactate, 3,8-diamino-6-phenylphenanthridine, 1,4-diaminopiperazine, 3,6-diaminoacridine, bis(4-aminophenyl)phenylamine, and the compounds represented by the following formulas (I-1) and (I-2), (i.e., diamines having two primary amino groups and a nitrogen atom except for the primary amino group in the molecule)

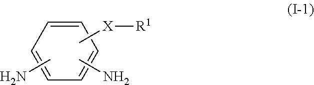

wherein, R¹ is a monovalent organic group that has a ring structure containing a nitrogen atom and that is selected from the group consisting of pyridine, pyrimidine, triazine, piperidine and piperazine, and X is a divalent organic group,

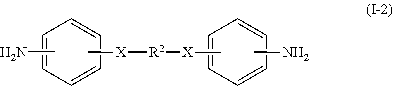

wherein, R² is a divalent organic group that has a ring structure containing a nitrogen atom and that is selected from the group consisting of pyridine, pyrimidine, triazine, piperidine and piperazine, and each X is independently a divalent organic group and may be the same or different,
the compounds represented by the following formulas (I-3) to (I-5)

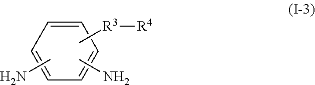

wherein, R³ is a divalent organic group selected from the group consisting of —O—, —COO—, —COO—, —NHCO—, —CONH—, and —CO—; R⁴ is a monovalent organic group having a group selected from the group consisting of a steroid skeleton, a trifluoromethyl group, and a fluoro group, or an alkyl group having 6 to 30 carbon atoms,

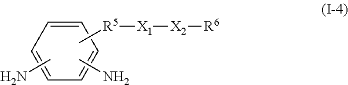

wherein, R⁵ is a divalent organic group selected from the group consisting of —O—, —COO—, —OCO—, —NHCO—, —CONH—, and —CO—; X₁ and X₂ are independently selected from the group consisting of an alicyclic group, an aromatic group, and a heterocyclic group; and R⁶ is selected from the group consisting of an alkyl group having 3 to 18 carbon atoms, an alkoxy group having 3 to 18 carbon atoms, a fluoroalkyl group having 1 to 5 carbon atoms, a fluoroalkoxy group having 1 to 5 carbon atoms, a cyano group, and a halogen atom,

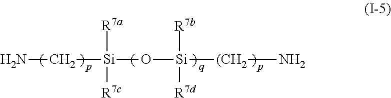

wherein, R^{7a}, R^{7b}, R^{7c}, R^{7d} are independently a hydrocarbon group having 1 to 12 carbon atoms and may be the same or different, each p is independently an integer ranging from 1 to 3, and q is an integer ranging from 1 to 20, the compounds represented by the following formulas (I-6) and (I-7),

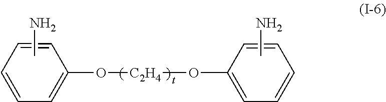

wherein, t is an integer ranging from 2 to 12,

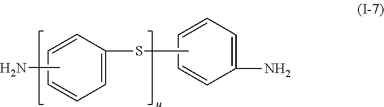

wherein, u is an integer ranging from 1 to 5, and the compounds represented by the following formulas (1) to (6),

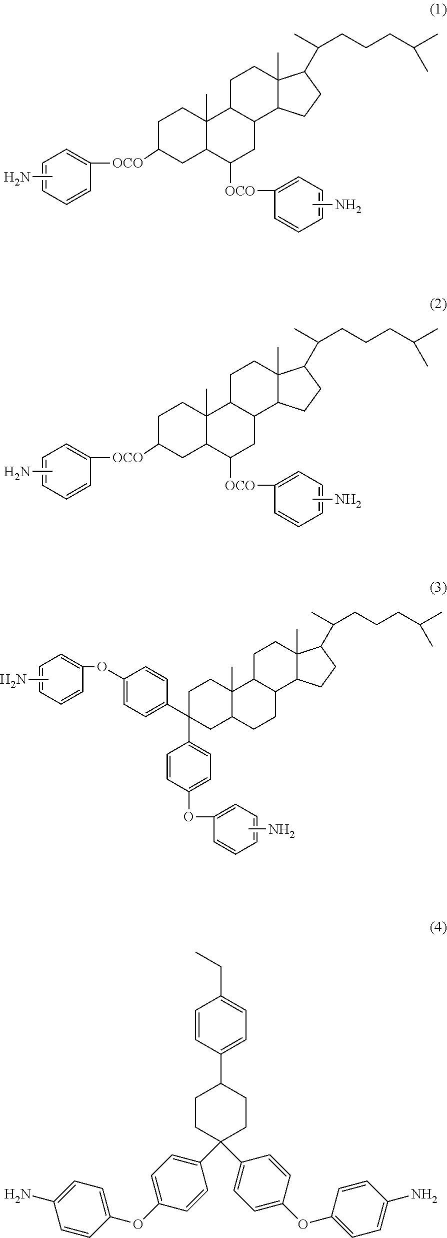

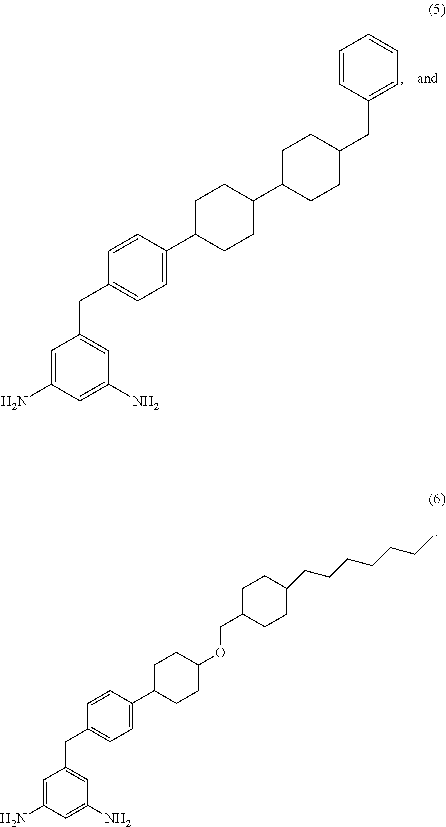

These diamine compounds may be used alone or in admixture of two or more.

Among the aforesaid diamine compounds, p-phenylenediamine, 4,4′-diaminodiphenyl methane, 4,4′-diaminodiphenyl sulfide, 1,5-diaminonaphthalene, 2,7-diaminofluorene, 4,4′-diaminodiphenyl ether, 2,2-bis[4-(4-aminophenoxy)phenyl]propane, 9,9-bis(4-aminophenyl)fluorene, 2,2-bis[4-(4-aminophenoxy)phenyl]hexafluoropropane, 2,2-bis(4-aminophenyl)hexafluoropropane, 4,4′-(p-phenyleneisopropylidene)bisaniline, 4,4′-(m-phenyleneisopropylidene)bisaniline, 1,4-diaminocyclohexane, 4,4′-methylene bis(cyclohexylamine), 1,4-bis(4-aminophenoxy)benzene, 4,4′-bis(4-aminophenoxy)biphenyl, 2,6-diaminopyridine, 3,4-diaminopyridine, 2,4-diaminopyrimidine, 3,6-diaminoacridine, the compounds represented by the aforementioned formulas (I) to (6), a compound represented by the following formula (7) selected from the compounds represented by the aforementioned formula (I-1), a compound represented by the following formula (8) selected from the compounds represented by the aforementioned formula (I-2), compounds represented by the following formulas (9) to (17) selected from the compounds represented by the aforementioned formula (I-3), compounds represented by the following formulas (18) to (20) selected from the compounds represented by the aforementioned formula (I-4), and liquid crystal diamino compounds represented by the following formulas (21) to (34) are preferred.

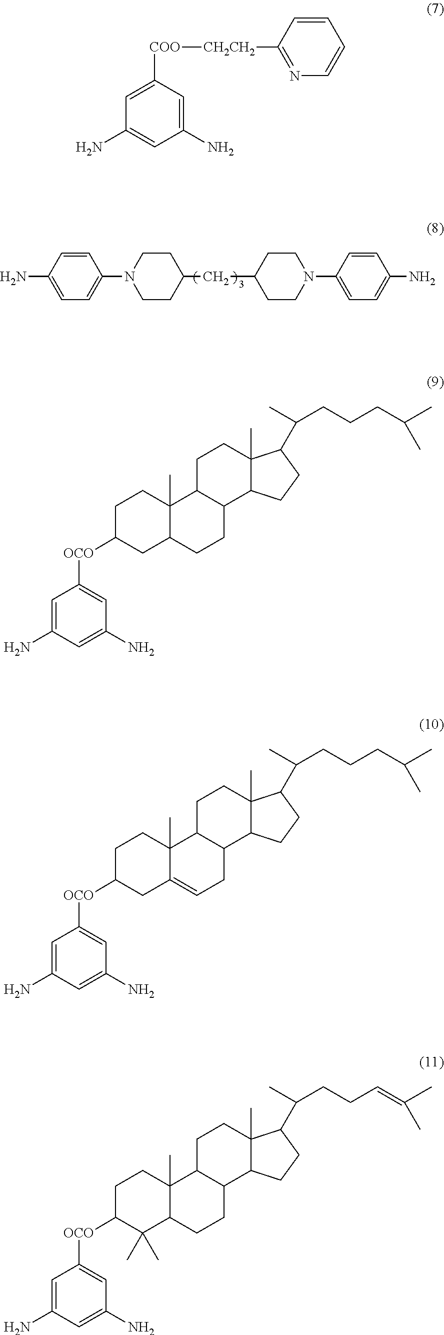

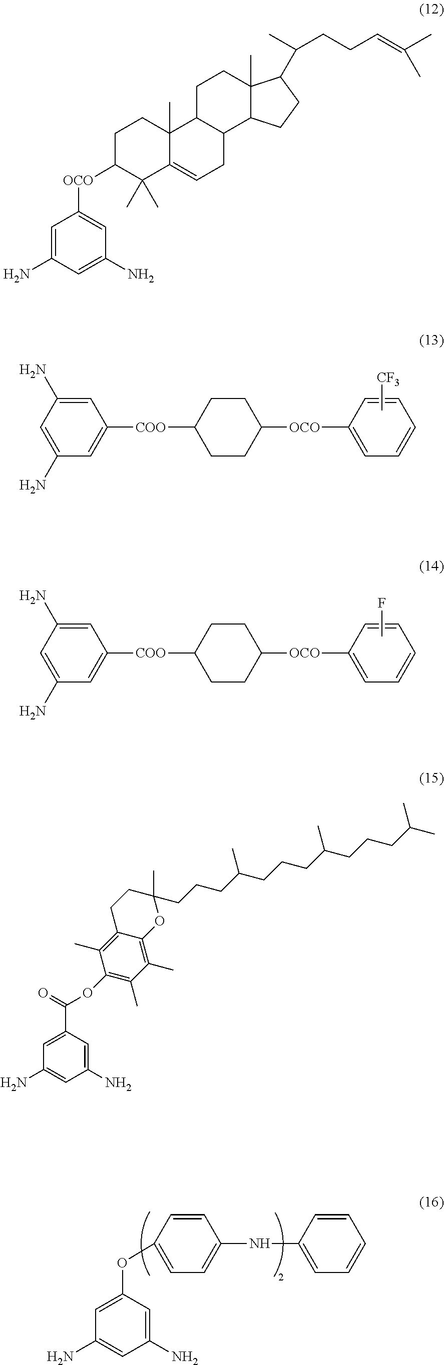

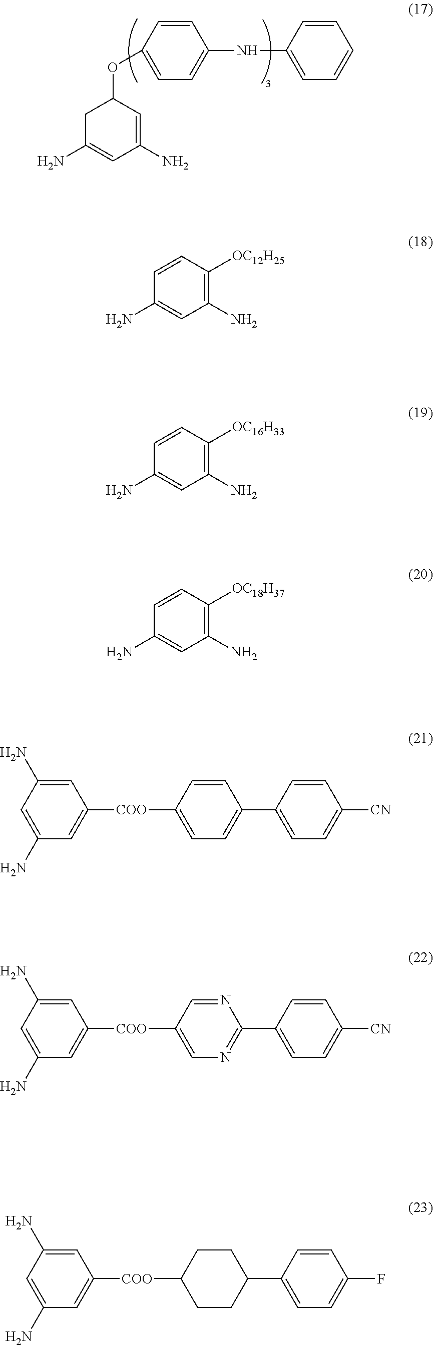

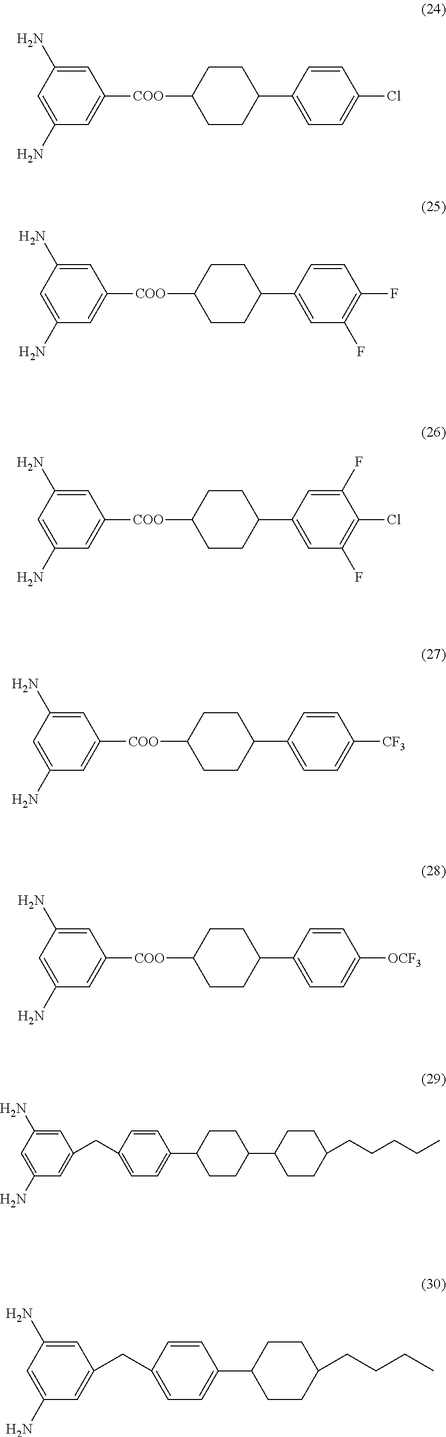

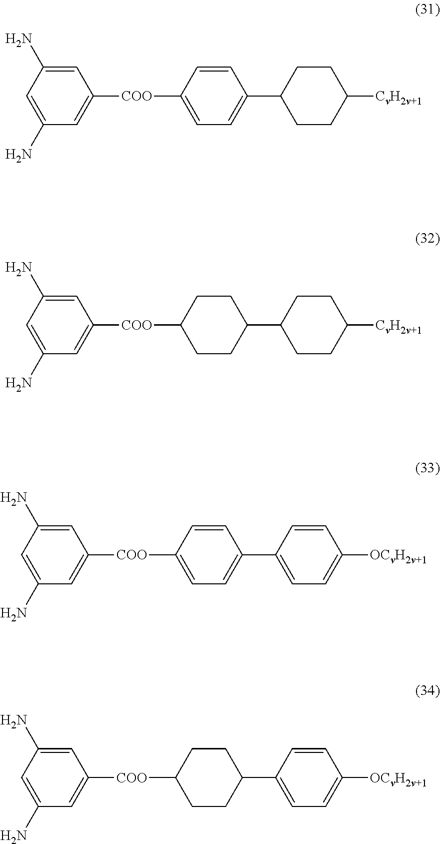

wherein, v is an integer ranging from 3 to 12.

The tetracarboxylic dianhydride compound suitable for the present invention is selected from aliphatic tetracarboxylic dianhydride, alicyclic tetracarboxylic dianhydride, and aromatic tetracarboxylic dianhydride. These teracarboxylic dianhydride compounds may be used alone or in admixture of two or more.

Examples of aliphatic tetracarboxylic dianhydride include ethanetetracarboxylic dianhydride, butanetetracarboxylic dianhydride, or the like.

Examples of alicyclic tetracarboxylic dianhydride include 1,2,3,4-cyclobutanetetracarboxylic dianhydride, 1,2-dimethyl-1,2,3,4-cyclobutanetetracarboxylic dianhydride, 1,3-dimethyl-1,2,3,4-cyclobutanetetracarboxylic dianhydride, 1,3-dichloro-1,2,3,4-cyclobutanetetracarboxylic dianhydride, 1,2,3,4-tetramethyl-1,2,3,4-cyclobutanetetracarboxylic dianhydride, 1,2,3,4-cyclopentanetetracarboxylic dianhydride, 1,2,4,5-cyclohexanetetracarboxylic dianhydride, 3,3′,4,4′-dicyclohexanetetracarboxylic dianhydride, cis-3,7-dibutylcycloheptyl-1,5-diene-1,2,5,6-tetracarboxylic dianhydride, 2,3,5-tricarboxylcyclopentylacetic dianhydride, 2,3,4,5-tetrahydrofurantetracarboxylic dianhydride, 3,4-dicarboxy-1,2,3,4-tetrahydronaphthalene-1-succinic acid dianhydride, 1,3,3a,4,5,9b-hexahydro-5-(tetrahydro-2,5-dioxo-3-furanyl)-naphtho[1,2-c]-furan-1,3-dione, 1,3,3a,4,5,9b-hexahydro-5-methyl-5-(tetrahydro-2,5-di oxo-3-furanyl)-naphtho[1,2-c]-furan-1,3-dione, 1,3,3a,4,5,9b-hexahydro-5-ethyl-5-(tetrahydro-2,5-dioxo-3-furanyl)-naphtho[1,2-c]-furan-1,3-dione, 1,3,3a,4,5,9b-hexahydro-7-methyl-5-(tetrahydro-2,5-di oxo-3-furanyl)-naphtho[1,2-c]-furan-1,3-dione, 1,3,3a,4,5,9b-hexahydro-7-ethyl-5-(tetrahydro-2,5-dioxo-3-furanyl)-naphtho[1,2-c]-furan-1,3-dione, 1,3,3a,4,5,9b-hexahydro-8-methyl-5-(tetrahydro-2,5-di oxo-3-furanyl)-naphtho[1,2-c]-furan-1,3-dione, 1,3,3a,4,5,9b-hexahydro-8-ethyl-5-(tetrahydro-2,5-dioxo-3-furanyl)-naphtho[1,2-c]-furan-1,3-dione, 1,3,3a,4,5,9b-hexahydro-5,8-dimethyl-5-(tetrahydro-2,5-dioxo-3-furanyl)-naphtho[1,2-c]-furan-1,3-dione, 5-(2,5-dioxotetrahydrofuranyl)-3-methyl-3-cyclohexene-1,2-dicarboxylic dianhydride, bicyclo[2.2.2]-octa-7-ene-2,3,5,6-tetracarboxylic dianhydride, and compounds represented by formulae (II-1) and (II-2):

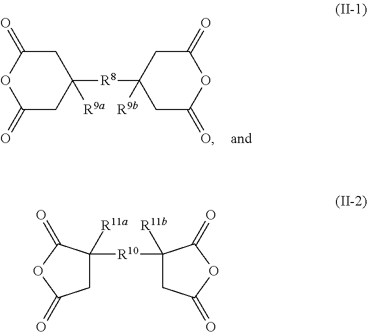

wherein, R⁸ and R¹⁰ are independently a divalent organic group containing an aromatic ring, and R^{9a}, R^{9b}, R^{11a}, and R^{11b} are independently a hydrogen atom or an alkyl group and may be the same or different.

Examples of aromatic tetracarboxylic dianhydride include pyromellitic dianhydride, 3,3′,4,4′-benzophenonetetracarboxylic dianhydride, 3,3′,4,4′-biphenylsulfonetetracarboxylic dianhydride, 1,4,5,8-naphthalenetetracarboxylic dianhydride, 2,3,6,7-naphthalenetetracarboxylic dianhydride, 3,3′-4,4′-biphenylethertetracarboxylic dianhydride, 3,3′,4,4′-dimethyldiphenylsilanetetracarboxylic dianhydride, 3,3′,4,4′-tetraphenylsilanetetracarboxylic dianhydride, 1,2,3,4-furantetracarboxylic dianhydride, 4,4′-bis(3,4-dicarboxyphenoxy)diphenylsulfide dianhydride, 4,4′-bis(3,4-dicarboxyphenoxy)diphenylsulfone dianhydride, 4,4′-bis(3,4-dicarboxyphenoxy)diphenylpropane dianhydride, 3,3′,4,4′-perfluoroisopropylidenediphthalic dianhydride, 3,3′,4,4′-biphenyltetracarboxylic dianhydride, bis(phthalic acid) phenylphosphine oxide dianhydride, p-phenylene-bis(triphenylphthalic acid) dianhydride, m-phenylene-bis(triphenylphthalic acid) dianhydride, bis(triphenylphthalic acid)-4,4′-diphenylether dianhydride,

bis(triphenylphthalic acid)-4,4′-diphenylmethane dianhydride, ethylene glycol-bis(anhydrotrimellitate), propylene glycol-bis(anhydrotrimellitate), 1,4-butanediol-bis(anhydrotrimellitate), 1,6-hexanediol-bis(anhydrotrimellitate), 1,8-octanediol-bis(anhydrotrimellitate), 2,2-bis(4-hydroxyphenyl)propane-bis(anhydrotrimellitate), and aromatic tetracarboxylic dianhydride compounds represented by the following formulae (35)-(38).

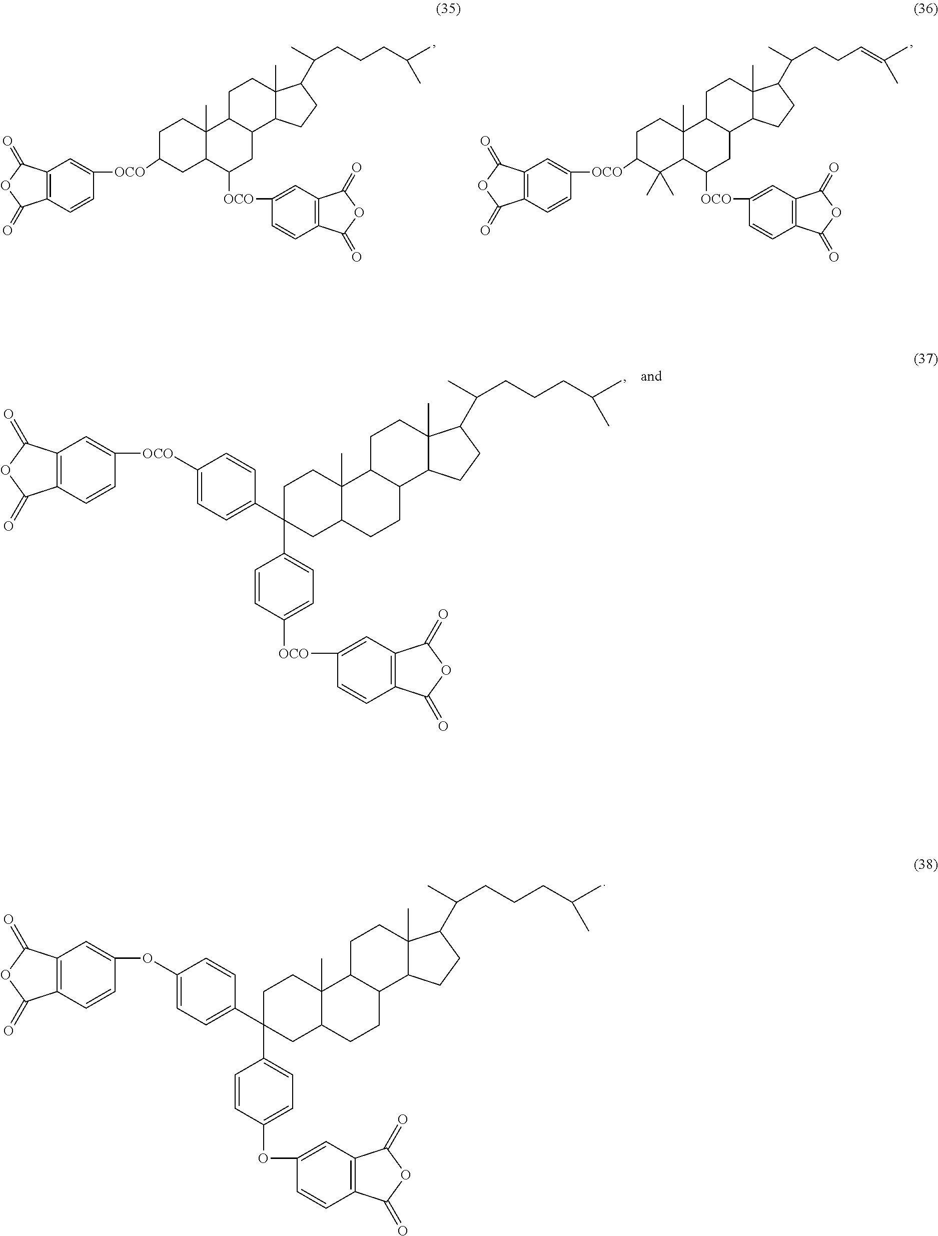

Preferably, the tetracarboxylic acid dianhydride compound is selected from 1,2,3,4-cyclobutane tetracarboxylic acid dianhydride, 1,2,3,4-cyclopentane tetracarboxylic acid dianhydride, 2,3,5-tricarboxycyclopentylacetic dianhydride, 3,4-dicarboxy-1,2,3,4-tetrahydronaphthalene-1-succinic acid dianhydride, pyromellitic dianhydride, 3,3′,4,4′-benzophenonetetracarboxylic dianhydride, and 3,3′,4,4′-biphenylsulfonetetracarboxylic dianhydride. More preferably, the compound represented by the aforementioned formula (II-1) is selected from the compounds represented by the following formulae (39)-(41), and the compound represented by the aforementioned formula (II-2) is the compound represented by the following formula (42):

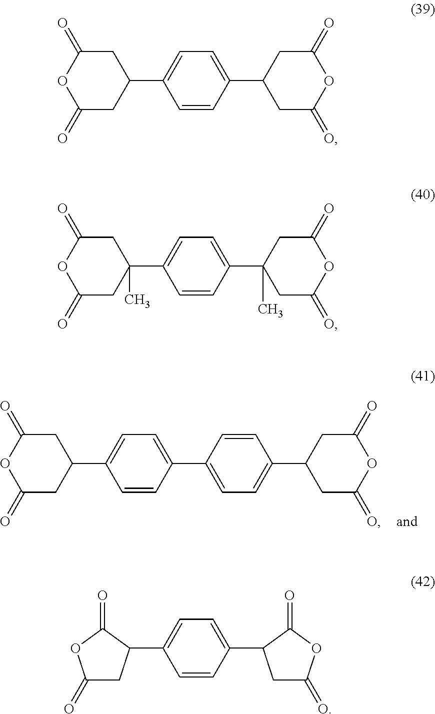

In the composition of the liquid crystal alignment agent of the present invention, the polymer obtained by subjecting the aforementioned diamine compound and the aforementioned tetracarboxylic acid dianhydride compound includes polyamic acid, and/or polyimide, and/or imide-based block copolymer. The imide-based block copolymer includes polyamic acid block copolymer, polyimide block copolymer, polyamic acid-polyimide block copolymer, or combinations thereof.

The preparations of the polyamic acid, the polyimide, and the imide-based block copolymer will be described in detail hereinbelow.

### Preparation of Polyamic Acid:

A polycondensation reaction between the diamine compound and the tetracarboxylic dianhydride compound is conducted in an organic solvent at a temperature ranging from 0 to 100° C. for a period ranging from 1 to 24 hours to obtain a reaction solution containing the obtained polyamic acid. The reaction solution is treated by pouring it into a large amount of poor solvent to obtain a precipitate, which is then dried under a reduced pressure to obtain the polyamic acid. Alternatively, the polyamic acid can be obtained by a treatment of distilling the reaction solution under a reduced pressure by means of an evaporator.

There is no particular limitation to the organic solvent for the polycondensation as long as the organic solvent is able to dissolve the reactants and the products. Examples of the organic solvent include aprotic polar solvents, such as N-methyl-2-pyrrolidone, N,N-dimethylacetamide, N,N-dimethylformamide, dimethylsulfoxide, γ-butyrolactone, tetramethylurea, hexamethylphosphortriamide, and the like; and phenolic solvents, such as m-cresol, xylenol, phenol, halogenated phenol, and the like.

The aforementioned organic solvents can be used in combination with a poor solvent, such as alcohols, ketones, esters, ethers, halogenated hydrocarbon compounds, hydrocarbon compounds, and the like in such an amount that does not cause precipitation of the formed polymer. Examples of the poor solvent include methyl alcohol, ethyl alcohol, isopropylalcohol, cyclohexanol, ethyleneglycol, propylene glycol, 1,4-butanediol, triethylene glycol, acetone, methyl ethyl ketone, methyl isobutyl ketone, cyclohexanone, methyl acetate, ethyl acetate, butyl acetate, diethyloxalate, diethylmalonate, diethylether, ethylene glycol methyl ether, ethylene glycol ethyl ether, ethylene glycol n-propyl ether, ethylene glycol isopropyl ether, ethylene glycol n-butyl ether, ethylene glycol dimethyl ether, ethylene glycol ethyl ether acetate, diethylene glycol dimethyl ether, tetrahydrofuran, dichloromethane, 1,2-dichloroethane, 1,4-dichlorobutane, trichloroethane, chlorobenzene, o-dichlorobenzene, hexane, heptane, octane, benzene, toluene, xylene, or the like.

### Preparation of Polyimide:

Polyimide in the present invention is obtained by further dehydration/ring-closure (imidization) processing of the aforesaid polyamic acid to transfer the amic acid functional group of the polyamic acid into the imido functional group.

Specifically, the imidization processing of the polyamic acid polymer is conducted by dissolving the polyamic acid in an organic solvent, and heating in the presence of a dehydrating agent and imidization catalyst to implement a dehydration/ring-closing reaction. In view of the imidization ratio, heating temperature for the imidization processing is generally from 40 to 200° C., and preferably from 80 to 150° C.

If the reaction temperature of the imidization processing is lower than 40° C., then the dehydration/ring-closing reaction cannot be fully implemented. On the other hand, if the reaction temperature exceeds 200° C., then the weight average molecular weight of the obtained polyimide is reduced.

Examples of the dehydrating agent suitable for the imidization processing include an acid anhydride compound, such as acetic anhydride, propionic anhydride, trifluoroacetic anhydride, and the like. The used amount of the dehydrating agent is preferably from 0.01 to 20 moles per mole of the polyamic acid. Examples of the imidization catalyst suitable for the imidization processing include pyridine, trimethylpyridine, dimethyl pyridine, tertiary amines (for example, triethylamine), and the like. The used amount of the imidization catalyst is preferably from 0.5 to 10 moles per mole of the dehydrating agent. The solvent used in the imidization processing is the same as the organic solvent useful for the aforementioned polycondensation reaction of the polyamic acid.

### Preparation of Imide-Based Block Copolymer:

An imide-based block copolymer in the present invention comprises polyamic acid block copolymer, polyimide block copolymer, polyamic acid-polyimide block copolymer, or combinations thereof.

In the preparation of the imide-based block copolymer, the imide-based block copolymer is obtained by further polycondensation reaction of compounds selected from the polyamic acid, the polyimide, diamine compounds, and tetracarboxylic dianhydride compounds in an organic solvent. In the polycondensation reaction for the imide-based block copolymer, the reaction temperature is generally from 0 to 200° C., preferably from 0 to 100° C., and examples of the solvent used for the polycondensation reaction are the same as those mentioned in the aforesaid polycondensation reaction for the polyamic acid.

Specifically, the imide-based block copolymer can be obtained by a polycondensation reaction of first and second polyamic acids which are different from each other in structures and terminal groups thereof; first and second polyimides which are different from each other in structures and terminal groups thereof; a polyamic acid and a polyimide which are different from each other in structures and terminal groups thereof; a polyamic acid, a diamine compound, and a tetracarboxylic dianhydride compound, wherein at least one of the diamine compound and the tetracarboxylic dianhydride compound is structurally different from the one used in the polycondensation reaction for the polyamic acid; a polyimide, a diamine compound, and a tetracarboxylic dianhydride compound, wherein at least one of the diamine compound and the tetracarboxylic dianhydride compound is structurally different from the one used in the polycondensation reaction for the polyimide; a polyamic acid, a polyimide, a diamine compound, and a tetracarboxylic dianhydride compound, wherein at least one of the diamine compound and the tetracarboxylic dianhydride compound is structurally different from the ones used in the polycondensation reaction for the polyamic acid and the polycondensation reaction for the polyimide; first and second polyamic acids, a diamine compound, and a tetracarboxylic dianhydride compound, wherein the first and second polyamic acids are structurally different from each other; first and secondpolyimides, a diamine compound, and a tetracarboxylic dianhydride compound, wherein the first and second polyimides are structurally different from each other; first and second polyamic acids and a diamine compound, wherein the first and second polyamic acids have anhydride terminal groups and are structurally different from each other; first and second polyamic acids and a tetracarboxylic dianhydride compound, wherein the first and second polyamic acids have amino terminal groups and are structurally different from each other; first and second polyimides and a diamine compound, wherein the first and second polyimides have anhydride terminal groups and are structurally different from each other; and first and second polyimides and a tetracarboxylic dianhydride compound, wherein the first and second polyimides have amino terminal groups and are structurally different from each other.

### Terminal Modified Polymer:

Additionally, the polyamic acid, the polyimide, and the imide-based block copolymer used in the present invention can also be the polymers which are terminal-modified after an adjustment of molecular weight thereof. The terminal-modified polymers can be used to improve properties, such as coating property and the like, of the liquid crystal alignment agent as long as they will not reduce the effects of the present invention. The process for synthesizing the terminal-modified polymers involves adding monofunctional compounds such as monoanhydride compounds, monoamine compounds, monoisocyanate compounds, or the like to the reaction system during the synthesis reaction for the polyamic acid.

Examples of the monoanhydride compounds include maleican hydride, phthalic anhydride, itaconican hydride, n-decyl succinican hydride, n-dodecyl succinic anhydride, n-tetradecyl succinic anhydride, n-hexadecyl succinic anhydride, and the like. Examples of monoamine compounds include aniline, cyclohexylamine, n-butylamine, n-amylamine, n-hexylamine, n-heptylamine, n-octylamine, n-nonylamine, n-decylamine, n-undecylamine, n-dodecylamine, n-tridecylamine, n-tetradecylamine, n-pentadecylamine, n-hexadecylamine, n-heptadecylamine, n-octadecylamine, n-eicosylamine, and the like. Examples of monoisocyanate compounds include phenyl isocyanate, naphthyl isocyanate, and the like.

Examples of the epoxy group containing compound include: dicyclopentadiene diepoxide, tricyclopentadiene diepoxide, tetracyclopentadiene diepoxide, pentacyclopentadiene diepoxide, ethylene glycol diglycidyl ether, polyethylene glycol diglycidyl ether, propylene glycol diglycidyl ether, tripropylene glycol diglycidyl ether, polypropylene glycol diglycidyl ether, neopentyl glycol diglycidyl ether, 1,6-hexanediol diglycidyl ether, glycerol diglycidyl ether, 2,2-dibromo-neopentyl glycol diglycidyl ether, 1,3,5,6-tetraglycidyl-2,4-hexanediol, N,N,N′,N′-tetraglycidyl-m-xylenediamine, 1,3-bis(N,N-diglycidylaminomethyl)cyclohexane, N,N,N′,N′-tetraglycidyl-4,4′-diaminodiphenyl methane, N,N-glycidyl-p-glycidyloxy aniline, 3-(N-allyl-N-glycidyl)aminopropyltrimethoxysilane, 3-(N,N-diglycidyl)aminopropyltrimethoxysilane, or combinations thereof.

Preferably, the epoxy group containing compound is selected from dicyclopentadiene diepoxide, tricyclopentadiene diepoxide, N,N,N′,N′-tetraglycidyl-4,4′-diaminodiphenyl methane, N,N-glycidyl-p-glycidyloxy aniline, and N,N,N′,N′-tetraglycidyl-m-xylenediamine. In the following examples, the epoxy group containing compound is selected from N,N,N′,N′-tetraglycidyl-4,4′-diaminodiphenyl methane (trade name: MY721, manufacturer: Vantico, Inc., Brewster, N.Y.), N,N-glycidyl-p-glycidyloxy aniline (trade name: JSR630, manufacturer: Japan Epoxy Resin Co. Ltd.), and N,N,N′,N′-tetragylcidyl-m-xylenediamine (trade name: GA240, manufacturer: CVC Chemical, Morrestown, N.J.).

The epoxy group containing compound is used in an amount ranging from 3 to 30 parts by weight, preferably from 5 to 25 parts by weight, and more preferably from 10 to 25 parts by weight based on 100 parts by weight of the polymer obtained by subjecting the diamine compound and the tetracarboxylic dianhydride compound to a polymerization reaction. When the epoxy group containing compound is not added in the liquid crystal alignment agent, the liquid crystal display element produced therefrom will have disadvantages of reduced voltage holding ratio and poor reliability.

It is noted that when the epoxy value of the liquid crystal alignment agent is between 0.06 and 0.7, a liquid crystal display element with good reliability is obtained. Preferably, the epoxy value of the liquid crystal alignment agent is between 0.1 and 0.6.

The curing promoter includes at least one of secondary amines, tertiary amines, quaternary ammonium compounds, organic phosphines, imidazoles, and tetraphenyl borates. The curing promoter is used in an amount ranging from 0.5 to 10 parts by weight based on 100 parts by weight of the polymer obtained by subjecting the diamine compound and the tetracarboxylic dianhydride compound to a polymerization reaction.

It is noted that when the curing promoter is used in an amount of less than 0.5 part by weight based on 100 parts by weight of the polymer, the reliability is poor. On the other hand, when the curing promoter is used in an amount of greater than 10 parts by weight, the voltage holding ratio is reduced. Therefore, the curing promoter is used in an amount ranging preferably from 0.5 to 10 parts by weight, more preferably from 0.5 to 9 parts by weight, and most preferably from 1 to 8 parts by weight.

Specifically, the curing promoter is selected from: secondary amines, such as diphenyleneamine, 2-phenylimidazoline, and di-2-ethylhexylamine; tertiary amines, such as 1,8-diazabicyclo[5.4.0]undec-7-ene, triethylenediamine, benzyldimethylamine, dodecyldimethylamine, 1,5-diazabicyclo[4.3.0]non-5-ene, and 5,6-dibutylamine-1,8-diazabicyclo[5.4.0]undec-7-ene; quaternary ammonium compounds, such as trimethylbenzylammonium bromide, triethylbenzylammonium chloride, tetrabutylammonium hydroxide, tetrabutylammonium bromide, benzyltrimethylammonium chloride, and tributyl hydroxyphenylammonium chloride; organic phosphines, such as tributylphosphine, methyldiphenylphosphine, triphenylphosphine, diphenylphosphine, phenylphosphine, and tri-(1-butyl-2,5-dihydroxyphenyl)phosphine; imidazoles, such as 2-methylimidazole, 2-ethylimidazole, 2-phenylimidazole, 2-ethyl-4-methylimidazole, 2-phenyl-4-methylimidazole, 2-heptadecaneimidazole, 2-undecaneimidazole, 1-benzil-2-methyl imidazole, 1-cyanoethyl-2-methylimidazole, 1-cyanoethyl-2-ethylimidazole, 1-cyanoethyl-2-undecaneimidazole, 2-ethyl-4,5-di(hydroxymethyl)imidazole, 2-alkylformylimidazole, benzimidazole, and 2-ethyl-4-methylimidazole tetramethylborate; and tetraphenyl borates, such as tetraphenylphosphonium tetraphenylborate, and N-methyl-morpholine tetraphenylborate. The curing promoter can be used alone or in admixture of two or more.

In the following examples, the curing promoter is selected from triphenylphosphine, 2-methylimidazole, tributylphosphine, diphenyleneamine, tetrabutylammonium bromide, and tetraphenylphosphonium tetraphenylborate.

### Formation of Liquid Crystal Alignment Film:

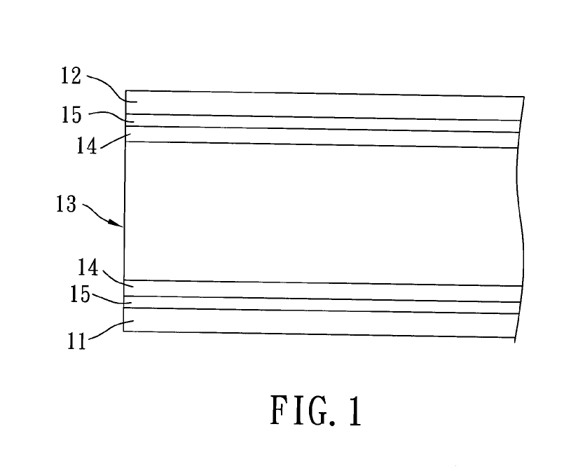

Referring to FIG. 1, a preferred embodiment of a liquid crystal display element according to the present invention includes a first substrate 11, a second substrate 12 spaced apart from the first substrate 11, two conductive films 15 respectively disposed on the first and second substrates 11, 12 and facing toward each other, two alignment layers 14 respectively disposed on the conductive films 15 and facing toward each other, and liquid crystal 13 disposed between the alignment layers 14.

The polymer obtained by subjecting the diamine composition and the tetracarboxylic dianhydride compound to a polymerization reaction, the epoxy group containing compound, and the curing promoter are dissolved in the organic solvent at a temperature ranging from 0 to 200° C. to form a liquid crystal alignment agent. The liquid crystal alignment agent is applied to each of the two conductive films 15 by a roller coating method, a spin coating method, a printing method, an ink-jet method, or the like to form a respective coating film. The coating films are heat-treated to form the alignment layers 14 on the two conductive films 15. The thickness of each alignment layer 14 ranges preferably from 0.001 to 1 μm, more preferably from 0.005 to 0.5 μm.

The aforesaid heat treatment for the coating film comprises pre-bake and post-bake treatments after coating the liquid crystal alignment agent. The pre-bake treatment causes the organic solvent to volatilize and form a coating film. Temperature for the pre-bake treatment is generally from 30 to 120° C., preferably from 40 to 110° C., and more preferably from 50 to 100° C. The post-bake treatment is further carried out to conduct a dehydration/ring-closure (imidization) reaction so as to form the alignment layer 14. Temperature for the post-bake treatment is generally from 150 to 300° C., preferably from 180 to 280° C., and more preferably from 200 and 250° C.

Concentration of the solid content in the liquid crystal alignment agent of the present invention is adjusted according to the properties such as viscosity, volatility, or the like, and ranges generally from 1 to 15 wt %, preferably from 2 to 15 wt %, and more preferably from 3 to 15 wt %. When the liquid crystal alignment agent of the present invention is coated on a substrate surface to form a liquid crystal alignment film, the coating characteristics of the liquid crystal alignment agent may be better if the concentration of the solid content of the liquid crystal alignment agent falls within the range of from 1 to 15 wt %.

The additives such as functional silane containing compounds may be added to the liquid crystal alignment agent of the present invention so as to improve adhesion of the liquid crystal alignment agent to the substrate to be applied as long as the intended properties of the liquid crystal alignment agent are not impaired.

Examples of the functional silane containing compounds include 3-aminopropyltrimethoxysilane, 3-aminopropyltriethoxysilane, 2-aminopropyltrimethoxysilane, 2-aminopropyltriethoxysilane, N-(2-aminoethyl)-3-aminopropyltrimethoxysilane, N-(2-aminoethyl)-3-aminopropylmethyldimethoxysilane, 3-ureidopropyltrimethoxysilane, 3-ureidopropyltriethoxysilane, N-ethoxycarbonyl-3-aminopropyltrimethoxysilane, N-ethoxycarbonyl-3-aminopropyltriethoxysilane, N-triethoxysilylpropyltriethylenetriamine, N-trimethoxysilylpropyltriethylenetriamine, 10-trimethoxysilyl-1,4,7-triazadecane, 10-triethoxysilyl-1,4,7-triazadecane, 9-trimethoxysilyl-3,6-diazanonylacetate, 9-triethoxysilyl-3,6-diazanonylacetate, N-benzyl-3-aminopropyltrimethoxysilane, N-benzyl-3-aminopropyltriethoxysilane, N-phenyl-3-aminopropyltrimethoxysilane, N-phenyl-3-aminopropyltriethoxysilane, N-bis(oxyethylene)-3-aminopropyltrimethoxysilane, N-bis(oxyethylene)-3-aminopropyltriethoxysilane, and the like.

Examples of the organic solvents used in the liquid crystal alignment agent of the present invention include 1-methyl-2-pyrrolidone, γ-butyrolactone, γ-butyrolactam, N,N-dimethylformamide, N,N-dimethylethanamide, 4-hydroxy-4-methyl-2-pentanone, ethylene glycol monomethyl ether, butyl lactate, butyl acetate, methyl methoxypropionate, ethyl ethoxypropionate, ethylene glycol methyl ether, ethylene glycol ethyl ether, ethylene glycol n-propyl ether, ethylene glycol isopropyl ether, ethylene glycol n-butyl ether (butyl cellosolve solvent), ethylene glycol dimethyl ether, ethylene glycol ethyl ether acetate, diglycol dimethyl ether, diglycol diethyl ether, diglycolmonomethyl ether, diglycolmonoethyl ether, diglycol monomethyl ether acetate, diglycol monoethyl ether acetate, and the like.

The liquid crystal alignment film 14 can be rubbed in a certain direction with a roller wound with a cloth made of nylon, rayon, or cotton fiber according to the requirements so as to afford the liquid crystal alignment film 14 with alignment energy. Moreover, protrusions can be formed on at least one substrate by widely known MVA (Multi-domain Vertical Alignment) or PVA (Patterned Vertical Alignment) methods to afford the liquid crystal molecules with the alignment energy for forming tilt in a predetermined angle.

### Liquid Crystal Display Element:

Referring to FIG. 1 again, the preferred embodiment of the liquid crystal display element of this invention has a structure as illustrated in FIG. 1. The first and second substrates 11, 12 suitable for the present invention are made of a transparent material, for example, alkali-free glass, soda-lime glass, hard glass (Pyrex glass), quartz glass, polyethylene terephthalate, polybutylene terephthalate, polyether sulphone, polycarbonate, or the like commonly used in liquid crystal display devices. The conductive films 15 may be a NESA® film (NESA® is the registered trademark of USA PPG Corporation) made of tin oxide (SnO₂), an ITO (indium tin oxide) film made of indium oxide-tin oxide (In₂O₃—SnO₂), or the like.

The liquid crystal 13 is disposed between the liquid crystal alignment films 14, is made of nematic liquid crystal material having dielectric anisotropy, and can be activated by the electric field produced by the conductive films 15. Examples of the nematic liquid crystal material include Shiff Base liquid crystals, azoxy liquid crystals, biphenyl liquid crystals, phenylcyclohexane liquid crystals, ester liquid crystals, terphenyl liquid crystals, biphenylcyclohexane liquid crystals, pyrimidine liquid crystals, dioxane liquid crystals, bicyclooctane liquid crystals, cubane liquid crystal, or the like. Moreover, cholesterol liquid crystals, such as cholesteryl chloride, cholesterylnonanoate, cholesteryl carbonate, or the like, and chiral agents sold under the trade names C-15, CB-15 (manufactured by Merck Company) may be added to the above liquid crystals, as required.

The liquid crystal alignment films 14 are respectively disposed on the conductive films 15 to provide the liquid crystal 13 disposed between the liquid crystal alignment films 14 with a pretilt angle. The first substrate 11 is a thin film transistor side substrate, and the second substrate 12 is a color filter side substrate.

The first and second substrates 11, 12 each having the liquid crystal alignment film 14 formed thereon are prepared and arranged to oppose each other with a space (cell gap). The peripheral portions of the first and second substrates 11, 12 are joined together with a sealing agent, liquid crystals are filled into the cell gap defined by the surfaces of the substrates 11, 12 and the sealing agent, and an injection hole is sealed up to form a liquid crystal cell. Then, a polarizer is affixed to the exterior sides of the liquid crystal cell (i.e., the other sides of the first and second substrates 11, 12 forming the liquid crystal cell) to obtain the liquid crystal display element.

The sealing agent may be a general epoxy resin hardening agent, and spacer material may be glass beads, plastic beads, photosensitive epoxy resin, or the like. In addition, the polarizer affixed to the exterior sides of the liquid crystal cell may be, for example, a polarizer comprising cellulose acetate protective films sandwiching the polarizing film called “H film” which has absorbed iodine while a polyvinyl alcohol is stretched and aligned, or a polarizer composed of the H film itself.

The following examples are provided to illustrate the preferred embodiments of the invention, and should not be construed as limiting the scope of the invention.

### SYNTHESIS EXAMPLES

### Synthesis of polymer (A)

[Synthesis of polyamic acid (A-1-1)]

A 500 ml four-necked conical flask equipped with a nitrogen inlet, a stirrer, a heater, a condenser and a thermometer was purged with nitrogen, and was added with a diamine compound having the aforementioned formula (15) (referred to as (a-1-1) hereinafter, 1.69 g, 0.003 mole), p-phenylenediamine (referred to as (a-1-4) hereinafter, 5.02 g, 0.047 mole), n-butylamine (0.22 g, 0.003 mole), and N-methyl-pyrrolidone (referred to as NMP hereinafter, 80 g). Stirring was conducted at room temperature until (a-1-1), (a-1-4) and n-butylamine were dissolved in NMP. Pyromellitic dianhydride (referred to as (a-2-1) hereinafter, 10.91 g, 0.05 mole) and NMP (20 g) were then added, and reaction was conducted for 2 hours at room temperature. The reaction solution was then poured into water (1500 ml) to precipitate a polymer. The polymer obtained after filtering was washed with methanol and filtered three times, and was dried in a vacuum oven at 60° C. to obtain polyamic acid (A-1-1).

[Synthesis of polyamic acid (A-1-2)]

A 500 ml four-necked conical flask equipped with a nitrogen inlet, a stirrer, a heater, a condenser and a thermometer was purged with nitrogen, and was added with the diamine compounds (a-1-1) (4.23 g, 0.0075 mole), (a-1-4) (2.97 g, 0.0275 mole), 4,4′-diaminodiphenyl methane (referred to as (a-1-5) hereinafter, 1.98 g, 0.015 mole) and NMP (80 g). Stirring was conducted at room temperature until (a-1-1), (a-1-4) and (a-1-5) were dissolved in NMP.

The (a-2-1) (5.46 g, 0.025 mole), 1,2,3,4-cyclobutane tetracarboxylic dianhydride (referred to as (a-2-2) hereinafter, 4.91 g, 0.025 mole), and NMP (20 g) were then added, and reaction was conducted for 2 hours at room temperature. The reaction solution was then poured into water (1500 ml) to precipitate a polymer. The polymer obtained after filtering was washed with methanol and filtered three times, and was dried in a vacuum oven at 60° C. to obtain polyamic acid (A-1-2).

[Synthesis of polyamic acid (A-1-3)]

A 500 ml four-necked conical flask equipped with a nitrogen inlet, a stirrer, a heater, a condenser and a thermometer was purged with nitrogen, and was added with a diamine compound having the aforementioned formula (4) (referred to as (a-1-2) hereinafter, 22.19 g, 0.040 mole), the diamine compound (a-1-5) (1.98 g, 0.010 mole), and NMP (80 g). Stirring was conducted at room temperature until (a-1-2) and (a-1-5) were dissolved in NMP.

The tetracarboxylic dianhydride (a-2-2) (9.81 g, 0.05 mole) and NMP (20 g) were then added, and reaction was conducted for 2 hours at room temperature. The reaction solution was then poured into water (1500 ml) to precipitate a polymer. The polymer obtained after filtering was washed with methanol and filtered three times, and was dried in a vacuum oven at 60° C. to obtain polyamic acid (A-1-3).

[Synthesis of polyimide (A-2-1)]

A 500 ml four-necked conical flask equipped with a nitrogen inlet, a stirrer, a heater, a condenser and a thermometer was purged with nitrogen, and was added with a diamine compound having the aforementioned formula (29) (referred to as (a-1-3) hereinafter, 3.25 g, 0.0075 mole), the diamine compound (a-1-4) (4.60 g, 0.0425 mole), and NMP (68 g). Stirring was conducted at 60° C. until (a-1-3) and (a-1-4) were dissolved in NMP. 3,4-dicarboxy-1,2,3,4-tetrahydronaphthalene-1-succinic dianhydride (referred to as (a-2-3) hereinafter, 15.01 g, 0.05 mole) and NMP (30 g) were then added, and reaction was conducted for 6 hours at room temperature. A reaction solution containing polyamic acid was obtained.

NMP (97 g), acetic anhydride (5.61 g) and pyridine (19.75 g) were then added to the reaction solution. Stirring was conducted for 2 hours at 60° C. to conduct an imidization reaction. The imidization reaction solution was then poured into water (1500 ml) to precipitate a polymer. The polymer obtained after filtering was washed with methanol and filtered three times, and was dried in a vacuum oven at 60° C. to obtain polyimide (A-2-1).

[Synthesis of polyimide (A-2-2)]

A 500 ml four-necked conical flask equipped with a nitrogen inlet, a stirrer, a heater, a condenser and a thermometer was purged with nitrogen, and was added with the diamine compound (a-1-3) (4.34 g, 0.01 mole), 4,4′-diaminodiphenyl ether (referred to as (a-1-6) hereinafter, 8.01 g, 0.04 mole), and NMP (68 g). Stirring was conducted at 60° C. until (a-1-3) and (a-1-6) were dissolved in NMP. The tetracarboxylic dianhydride compound (a-2-3) (15.01 g, 0.05 mole) and NMP (30 g) were then added, and reaction was conducted for 6 hours at room temperature. A reaction solution containing polyamic acid was obtained.

NMP (97 g), acetic anhydride (5.61 g) and pyridine (19.75 g) were then added to the reaction solution. Stirring was conducted for 2 hours at 60° C. to conduct an imidization reaction. The imidization reaction solution was then poured into water (1500 ml) to precipitate a polymer. The polymer obtained after filtering was washed with methanol and filtered three times, and was dried in a vacuum oven at 60° C. to obtain polyimide (A-2-2).

[Synthesis of polyimide (A-2-3)]

A 500 ml four-necked conical flask equipped with a nitrogen inlet, a stirrer, a heater, a condenser and a thermometer was purged with nitrogen, and was added with the diamine compound (a-1-1) (1.69 g, 0.003 mole), the diamine compound (a-1-5) (9.31 g, 0.047 mole), and NMP (100 g). Stirring was conducted at room temperature until (a-1-1) and (a-1-5) were dissolved in NMP.

The tetracarboxylic dianhydride compound (a-2-2) (16.11 g, 0.05 mole) and NMP (205.42 g) were then added, and reaction was conducted for 6 hours at room temperature. NMP (94.02 g), acetic anhydride (5.61 g) and triethyl amine (15.15 g) were then added to the reaction solution. Stirring was conducted for 2 hours at 110° C. to conduct an imidization reaction. The reaction solution was then poured into water (1500 ml) to precipitate a polymer. The polymer obtained after filtering was washed with methanol and filtered three times, and was dried in a vacuum oven at 60° C. to obtain polyimide (A-2-3).

[Synthesis of polyimide (A-2-4)]

A 500 ml four-necked conical flask equipped with a nitrogen inlet, a stirrer, a heater, a condenser and a 2-0 thermometer was purged with nitrogen, and was added with the diamine compound (a-1-1) (1.69 g, 0.003 mole), the diamine compound (a-1-6) (9.31 g, 0.047 mole), and NMP (100 g). Stirring was conducted at room temperature until (a-1-1) and (a-1-6) were dissolved in NMP).

The tetracarboxylic dianhydride compound (a-2-3) (16.11 g, 0.05 mole) and NMP (205.42 g) were then added, and reaction was conducted for 6 hours at room temperature. Thereafter, phenylamine (0.09 g, 0.001 mole) was added, and reaction was conducted for 2 hours at room temperature. NMP (94.02 g), acetic anhydride (5.61 g) and pyridine (19.75 g) were then added to the reaction solution. Stirring was conducted for 2 hours at 110° C. to conduct an imidization reaction. The reaction solution was then poured into water (1500 ml) to precipitate a polymer. The polymer obtained after filtering was washed with methanol and filtered three times, and was dried in a vacuum oven at 60° C. to obtain polyimide (A-2-4).

[Synthesis of imide-based block copolymer (A-3-1)]

The polyamic acid (A-1-1) and the polyimide (A-2-3) obtained were mixed in a solution, and were stirred at 60° C. for 6 hours to conduct a copolymerization reaction. The reaction solution was then poured into water (1500 ml) to precipitate a polymer. The polymer obtained after filtering was washed with methanol and filtered three times, and was dried in a vacuum oven at 60° C. to obtain a polyamic acid-polyimide block copolymer (A-3-1).

The compositions of the polyamic acid (A-1-1) to (A-1-3) and the polyimide (A-2-1) to (A-2-4) are collectively shown in Table 1.

TABLE 1

| | | Synthesis Examples | | | | | | |
|---|---|---|---|---|---|---|---|---|
| | | 1 | 2 | 3 | 4 | 5 | 6 | 7 |
| Components | | A-1-1 | A-1-2 | A-1-3 | A-2-1 | A-2-2 | A-2-3 | A-2-4 |
| Diamine compounds | a-1-1 | 6 | 15 | | | | 6 | 6 |
| (mole %) | a-1-2 | | | 80 | | | | |
| | a-1-3 | | | | 15 | 20 | | |
| | a-1-4 | 94 | 55 | | 85 | | | |
| | a-1-5 | | 30 | 20 | | | 94 | |
| | a-1-6 | | | | | 80 | | 94 |
| Tetracarboxylic | a-2-1 | 100 | 50 | | | | | |
| dianhydride | a-2-2 | | 50 | 100 | | | 100 | |
| compounds(mole %) | a-2-3 | | | | 100 | 100 | | 100 |

Compounds:
a-1-1: a compound having the aforementioned formula (15)
a-1-2: a compound having the aforementioned formula (4)
a-1-3: a compound having the aforementioned formula (29)
a-1-4: p-phenylenediamine
a-1-5: 4,4′-diaminodiphenyl methane
a-1-6: 4,4′-diaminodiphenyl ether
a-2-1: pyromellitic dianhydride
a-2-2: 1,2,3,4-cyclobutane tetracarboxylic dianhydride

### EXAMPLES

### Example 1

100 parts by weight of the polymer (A-1-1), 5 parts by weight of N,N,N′,N′-tetraglycidyl-4,4′-diaminodiphenyl methane (referred to as B-1 hereinafter, trade name: MY721, manufacturer: Vantico, Inc., Brewster, N.Y.), and 0.5 part by weight of 1,8-diazabicyclo[5.4.0]undec-7-ene (referred to as C-1 hereinafter) were dissolved in a co-solvent of 1000 parts by weight of NMP (D-1)/800 parts by weight of ethylene glycol n-butyl ether (D-2) at room temperature to obtain a liquid crystal alignment agent. The epoxy value of the liquid crystal alignment agent was measured by a method which will be described later.

The liquid crystal alignment agent was coated onto two glass substrates each having an ITO (indium-tin-oxide) conductive film using a printing machine (manufactured by Japan Nissha Printing Co., Ltd., Model S15-036), after which the glass substrates coated with the alignment agent solution were pre-baked on a heating plate at a temperature of 100° C. for five minutes, and were then post-baked in a hot air circulation baking oven at a temperature of 220° C. for 30 minutes to form a film on each of the glass substrates. The thickness of the film was measured to be around 800±200 Å using a film thickness measuring device (manufactured by KLA-Tencor, Model Alpha-step 500). An alignment (rubbing) process was carried out on the surface of the film using a rubbing machine (Model RMO2-11 manufactured by Iinuma Gauge Mfg. Co., Ltd.). The stage moving rate was 50 mm/sec. When rubbing, a hair push-in length was 0.3 mm, and was unidirectionally rubbed once.

Thermo-compression adhesive agent was applied to one of the glass substrates formed with the liquid crystal alignment films, and spacers of 4 μm were sprayed on the other of the glass substrates formed with the liquid crystal alignment films. The two glass substrates were aligned and bonded together in a vertical direction of alignment, and then 10 kg of pressure was applied using a thermo-compressor to carry out thermo-compression at 150° C. Liquid crystal was poured using a liquid crystal pouring machine (manufactured by Shimadzu Corporation, Model ALIS-100X-CH), ultraviolet light was then used to harden a sealant to seal the liquid crystal injection hole, and an annealing treatment was conducted in an oven at 60° C. for 30 minutes, thereby manufacturing a liquid crystal display element. Voltage holding ratio and reliability of the liquid crystal display element were measured.

### [Steps for Measuring Epoxy Value of Liquid Crystal Alignment Agent]

1. 0.5-0.6 g of the liquid crystal alignment agent was scaled in a 100 ml Erlenmeyer flask with cap and the weight or scaling value (S, g) was recorded.

2. 20 ml of an acetic acid/benzene (volume ratio: 1/1) solution was added into the 100 ml Erlenmeyer flask to dissolve the liquid crystal alignment agent.

3. 3 drops of phenolphthalein indicator (1%) were added into the 100 ml Erlenmeyer flask.

4. 5 drops of a crystal-violet indicator were added into the 100 ml Erlenmeyer flask.

5. Titration was conducted using 0.1 N hydrogen bromide/acetic acid solution.

6. The titration amount (V, ml) was recorded when the color of the solution changed to blue green from purple and maintained for 30 seconds, i.e., when the titration end-point was reached.

### [Calculation of Epoxy Value of Liquid Crystal Alignment Agent]

The epoxy value of the liquid crystal alignment agent

(O)=[(V−B)×F×0.16]/S

S: weight of the liquid crystal alignment agent (g)

V: amount of titration (ml)

B: amount of titration required for blank test (ml)

F: titration coefficient of a hydrogen bromide/acetic acid titration solution

### [Standardization of Titration Coefficient of Hydrogen Bromide/Acetic Acid Solution]

1. 0.1 g of Na₂CO₃ (preliminarily dried for 1 hour at 600° C.) was scaled in a 100 ml Erlenmeyer flask with cap and the weight or scaling value (w, g) was recorded.

2. 20 ml of an acetic acid/benzene (volume ratio: 1/1) solution was added into the 100 ml Erlenmeyer flask.

3. 10 drops of a crystal-violet indicator were added into the 100 ml Erlenmeyer flask.

4. Titration was conducted using 0.1N hydrogen bromide/acetic acid solution.

5. The titration amount (A, ml) was recorded when the color of the solution changed to blue green from purple, i.e., when the titration end-point was reached.

F=weight of Na₂CO₃(w)/(0.0053×A)

### [Method of Measuring Voltage Holding Ratio of Liquid Crystal Display Element]

Voltage holding ratio was measured using an electrical measuring machine (manufactured by TOYO Corporation, Model 6254).

A voltage of 4 volts was applied for 120 microseconds. The applied voltage was held for 16.67 milliseconds. After the applied voltage was cut off for 16.67 milliseconds, the voltage holding ratio was measured and evaluated according to the following standards:

\hat{∘}: voltage holding ratio≧98%

◯: 98%>voltage holding ratio≧96%

Δ: 96%>voltage holding ratio≧94%

X: voltage holding ratio<94%

### [Method of Measuring Reliability of Liquid Crystal Display Element]

The reliability of the liquid crystal display element was carried out at a temperature of 65° C. and relative humidity of 85% for 120 hours, and then the voltage holding ratio was measured using the aforesaid evaluation method. The reliability of the liquid crystal display element was evaluated according to the following standards:

\hat{∘}: Voltage holding ratio≧94%

◯: 94%>Voltage holding ratio≧92%

Δ: 92%>Voltage holding ratio≧90%

X: Voltage holding ratio<90%

### Examples 2 to 9

Examples 2 to 9 were conducted in a manner identical to that of Example 1 by using the polymers, the epoxy group containing compounds, the curing promoters, and the organic solvents shown in Table 2. The epoxy value, the voltage holding ratio, the reliability of the liquid crystal display elements obtained in Examples 2 to 9 were respectively measured and evaluated in a manner identical to that of Example 1, and the results are shown in Table 2.

### Comparative Examples 1 to 7

Comparative Examples 1 to 7 were conducted in a manner identical to that of Example 1 by using the polymers, the epoxy group containing compounds, the curing promoters, and the organic solvents shown in Table 2. The epoxy value, the voltage holding ratio, and the reliability of the liquid crystal display elements obtained in Comparative Examples 1 to 7 were respectively measured and evaluated in a manner identical to that of Example 1, and the results are shown in Table 2.

### Comparative Example 8

100 parts by weight of the polymer (A-1-1), 5 parts by weight of B-1, and 1 part by weight of C-1 were dissolved in a co-solvent of 1000 parts by weight of D-1/800 parts by weight of D-2 at room temperature to obtain a liquid crystal alignment agent.

A liquid crystal display element was manufactured in a manner identical to that of Example 1. The epoxy value, the voltage holding ratio, and the reliability of the liquid crystal display element were respectively measured and evaluated in a manner identical to that of Example 1, and the measured voltage holding ratio and reliability are all X.

TABLE 2

| | | Examples | | | | | | | | |
|---|---|---|---|---|---|---|---|---|---|---|
| Components | | 1 | 2 | 3 | 4 | 5 | 6 | 7 | 8 | 9 |
| Polymers | A-1-1 | 100 | | | | | | | | |
| (PBW) | A-1-2 | | 100 | | | | | | 50 | |
| | A-1-3 | | | 100 | | | | | | |
| | A-2-1 | | | | 100 | | | | | 50 |
| | A-2-2 | | | | | 100 | | | 50 | |
| | A-2-3 | | | | | | 100 | | | |
| | A-2-4 | | | | | | | | | |
| | A-3-1 | | | | | | | 100 | | 50 |
| Epoxy group | B-1 | 5 | | | 15 | | | 15 | 5 | |
| containing | B-2 | | 10 | | | | | 10 | | 15 |
| compounds | B-3 | | | | | 15 | | | | |
| (PBW) | B-4 | | | 3 | | | 20 | | 25 | |
| Curing | C-1 | 0.5 | | | | | | 1 | | 8 |
| promoters | C-2 | | 2 | | | | | | | |
| (PBW) | C-3 | | | 4 | | | | | 2 | |
| | C-4 | | | | 6 | | | | | |
| | C-5 | | | | | 9 | | | 1 | |
| | C-6 | | | | | | 10 | | | |
| Organic | D-1 | 1000 | | 100 | 1500 | 1000 | 1000 | 1000 | | 1000 |
| solvents | D-2 | 800 | 1000 | | | | 800 | | 1800 | 800 |
| (PBW) | D-3 | | 800 | 800 | | 500 | | 500 | | |
| Epoxy value | | 0.10 | 0.23 | 0.06 | 0.35 | 0.47 | 0.48 | 0.59 | 0.67 | 0.38 |
| Results | Voltage | ◯ | ⊚ | ⊚ | ⊚ | ◯ | ◯ | ⊚ | ⊚ | ⊚ |
| | holding | | | | | | | | | |
| | ratio | | | | | | | | | |
| | Reliability | ◯ | ⊚ | ◯ | ⊚ | ⊚ | ⊚ | ⊚ | ◯ | ⊚ |

| | | Comparative Examples | | | | | | |
|---|---|---|---|---|---|---|---|---|
| Components | | 1 | 2 | 3 | 4 | 5 | 6 | 7 |
| Polymers | A-1-1 | 100 | | | | | | |
| (PBW) | A-1-2 | | | 100 | | | | |
| | A-1-3 | | | | | 100 | | |
| | A-2-1 | | 100 | | | | | |
| | A-2-2 | | | | 100 | | | |
| | A-2-3 | | | | | | 100 | |
| | A-2-4 | | | | | | | 100 |
| | A-3-1 | | | | | | | |
| Epoxy group | B-1 | 5 | | | | | | |
| containing | B-2 | | 10 | | | | | 20 |
| compounds | B-3 | | | 15 | | | | |
| (PBW) | B-4 | | | | 20 | | 25 | |
| Curing | C-1 | 0.3 | | 15 | | 3 | | |
| promoters | C-2 | | 0.2 | | | | | |
| (PBW) | C-3 | | | | 20 | | | |
| | C-4 | | | | | | | |
| | C-5 | | | | | | | |
| | C-6 | | | | | | | |
| Organic | D-1 | 1000 | | 1000 | 1500 | 1000 | | |
| solvents | D-2 | 800 | 1000 | | | | 1800 | |
| (PBW) | D-3 | | 800 | 800 | | 800 | | 1500 |
| Epoxy value | | 0.10 | 0.22 | 0.41 | 0.61 | 0.00 | 0.57 | 0.53 |
| Results | Voltage | Δ | Δ | X | X | X | X | X |
| | holding | | | | | | | |
| | ratio | | | | | | | |
| | Reliability | X | X | Δ | Δ | X | X | X |

PBW: parts by weight
B-1: N,N,N′,N′-tetragylcidyl-4,4′-diaminodiphenyl methane, trade name: MY721
B-2: N,N-glycidyl-p-epoxypropoxyphenylamine, (trade name: JSR630)
B-3: dicyclopentadienyl diepoxide
B-4: N,N,N′,N′-tetragylcidyl-m-xylenediamine, trade name: GA240
C-1: 1,8-diazabicyclo[5.4.0]undec-7-ene
C-2: 2-methylimidazole
C-3: tributylphosphine
C-4: diphenyleneamine
C-5: tetrabutylammonium bromide
C-6: tetraphenylphosphonium tetraphenylborate
D-1: N-methyl-pyrrolidone
D-2: ethylene glycol n-butyl ether
D-3: N,N-dimethylacetamide

It can be seen from Table 2 that the liquid crystal display element of the present invention, which includes a liquid crystal alignment agent having an epoxy group containing compound and a curing promoter with an amount ranging from 0.5 to 10 parts by weight, possesses improved voltage holding ratio and reliability.

While the present invention has been described in connection with what are considered the most practical and preferred embodiments, it is understood that this invention is not limited to the disclosed embodiments but is intended to cover various arrangements included within the spirit and scope of the broadest interpretation and equivalent arrangements.

What is claimed is:

1. A liquid crystal alignment agent, comprising:
a polymer obtained by subjecting a diamine compound and a tetracarboxylic dianhydride compound to a polymerization reaction;
an epoxy group containing compound; and
a curing promoter,
said curing promoter being at least one compound selected from the group consisting of secondary amines, tertiary amines, quaternary ammonium compounds, organic phosphines, imidazoles, and tetraphenyl borates, and being in an amount ranging from 0.5 to 10 parts by weight based on 100 parts by weight of said polymer.

2. The liquid crystal alignment agent as claimed in claim 1, wherein said curing promoter is in an amount ranging from 0.5 to 9 parts by weight based on 100 parts by weight of said polymer.

3. The liquid crystal alignment agent as claimed in claim 1, wherein said curing promoter is in an amount ranging from 1 to 8 parts by weight based on 100 parts by weight of said polymer.

4. The liquid crystal alignment agent as claimed in claim 1, wherein said liquid crystal alignment agent has an epoxy value ranging from 0.06 to 0.70.

5. The liquid crystal alignment agent as claimed in claim 4, wherein said liquid crystal alignment agent has an epoxy value ranging from 0.10 to 0.60.

6. A liquid crystal alignment film formed from the liquid crystal alignment agent as claimed in claim 1.

7. A liquid crystal display element, comprising the liquid crystal alignment film as claimed in claim 6.
